(19) United States
(12) Patent Application Publication
(10) Pub. No.: US 2019/0196794 A1
(43) Pub. Date: Jun. 27, 2019

(54) VISUAL PROGRAMMING METHOD, SYSTEM AND TERMINAL DEVICE

(71) Applicant: UBTECH Robotics Corp, Shenzhen (CN)

(72) Inventors: Youjun Xiong, Shenzhen (CN); Haiwu Su, Shenzhen (CN)

(21) Appl. No.: 15/891,382

(22) Filed: Feb. 8, 2018

(30) Foreign Application Priority Data
Dec. 26, 2017 (CN) 201711433934.4

(51) Int. Cl. G06F 8/34; G06F 8/30; G06F 8/33; G06F 8/71

(52) U.S. Cl. CPC G06F 8/34; G06F 8/71; G06F 8/33; G06F 8/315

(57) ABSTRACT

The present disclosure provides a visual programming method, system and terminal device. The method includes: updating a primitive information module of a local storage space when a remote server is detected as including the primitive information module of a new version; initializing a visual programming main interface; obtaining a dummy primitive object selected by a user in the visual programming main interface; searching for a real primitive object corresponding to the dummy primitive object basing on primitive information of the dummy primitive object; and instantiating the real primitive object, and replacing the dummy primitive object with the real primitive object. The present disclosure can improve the online operation smoothness of the operation interface when Blockly technology is deployed on a mobile terminal platform, and reduce the download volume.

### CROSS REFERENCE TO RELATED APPLICATIONS

This application claims priority to Chinese Patent Application No. 201711433934.4, filed Dec. 26, 2017, which is hereby incorporated by reference herein as if set forth in its entirety.

### BACKGROUND

### 1. Technical Field

The present disclosure relates to primitive visualization technology, and particularly to a visual programming method, system and terminal device.

### 2. Description of Related Art

In recent years, Blockly technology has been widely used in the fields of intelligence development and education due to its puzzle and flexibility in development applications. Blockly technology applications are generally deployed on mobile terminal platforms for the convenience of home entertainment.

However, in the prior art, when Blockly technology is deployed on a mobile terminal platform and operated online, operation interface lags tend to occur. Furthermore, it takes a long time to download the installation package when the Blockly technology is deployed for the first time to realize full localization, and it takes a long time to download the upgrade package when the Blockly technology is upgraded after full localization, which has poor user experience.

### BRIEF DESCRIPTION OF THE DRAWINGS

To describe the technical schemes in the embodiments of the present disclosure more clearly, the following briefly introduces the drawings required for describing the embodiments or the prior art. Apparently, the drawings in the following description merely show some examples of the present disclosure. For those skilled in the art, other drawings can be obtained according to the drawings without creative efforts.

FIG. 1 is a flow chart of a visual programming method according to a first embodiment of the present disclosure.

FIG. 2 is a flow chart of a visual programming method according to a second embodiment of the present disclosure.

FIG. 3 is a flow chart of a visual programming method according to a third embodiment of the present disclosure.

FIG. 4 is a schematic diagram of a visual programming system according to a fourth embodiment of the present disclosure.

FIG. 5 is a schematic diagram of a visual programming system according to a fifth embodiment of the present disclosure.

FIG. 6 is a schematic diagram of a visual programming system according to a sixth embodiment of the present disclosure.

FIG. 7 is a schematic diagram of a terminal device according to a seventh embodiment of the present disclosure.

### DETAILED DESCRIPTION

In order to make those skilled in the art better understand the solutions of the present disclosure, the technical solutions in the embodiments of the present disclosure will be described clearly below with reference to the accompanying drawings in the embodiments of the present disclosure. Apparently, the described embodiments are merely part of the embodiments of the present disclosure, but not all of the embodiments. All other embodiments obtained by those skilled in the art based on the embodiments of the present disclosure without creative efforts shall fall within the protection scope of the present disclosure.

The terms “comprising”, “including” and their variations in the description, the claims and the above-mentioned drawings of the present disclosure are intended to cover a non-exclusive inclusion. For example, a process, method, or system, product, or device that includes a series of steps or units is not limited to the steps or units listed, but may optionally further include steps or units not listed or may optionally further include other steps or units inherent to these processes, methods, products or devices. In addition, the terms “first,” “second,” “third” and the like are used to distinguish different objects, rather than to describe a particular order.

For the purpose of illustrating the technical solutions of the present disclosure, the following describes the specific embodiments.

### Embodiment One

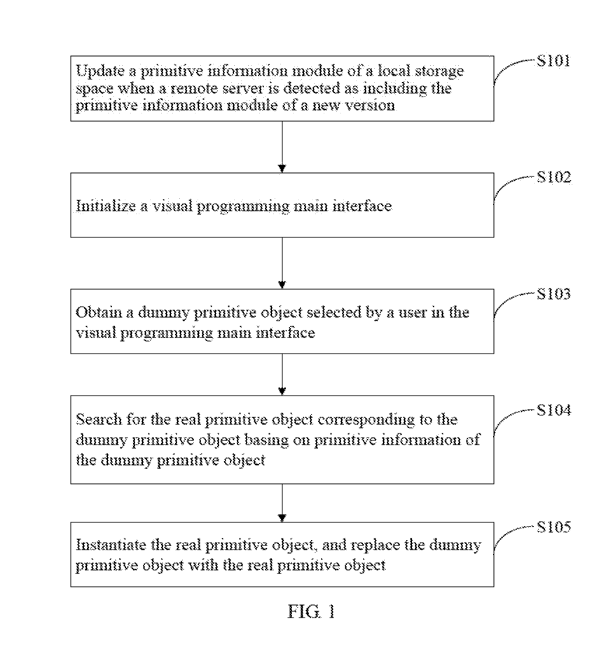

FIG. 1 is a flow chart of a visual programming method according to a first embodiment of the present disclosure. In this embodiment, the method is a computer-implemented method executable for a processor. The method can be applied to terminal devices such as cell phones, tablet computers, notebook computers, and cloud servers. As shown in FIG. 1, the method includes the following steps.

S101: updating a primitive information module of a local storage space when a remote server is detected as including the primitive information module of a new version.

In this embodiment, the term “primitive” refers to the functions for describing various graphical elements in a graphics software package, which has the full name of “graphics output primitive”.

The primitive information module is used to describe the primitive information of a primitive extension module. The primitive information module includes a primitive category tree description, a primitive classification description, a primitive version description, a primitive interface description, and a primitive resource location and the like, and can also include other primitive information descriptions.

In which, the primitive category tree description refers to tree-shaped description information formed according to category characteristic information of a primitive, where the branches of the tree has the relationship of superior and inferior. For example, square primitives are inferior primitives that are subordinate to a square primitive branch of the category tree description.

The primitive classification description refers to description information composed based on primitive classification characteristic information, and is mainly classified according to the function type of a primitive elements. For example, the function type of a primitive element describing a geometric element is a geometric type.

The primitive version description refers to description information composed based on primitive version information. It can be used to determine the update of the primitive. For example, it is determined that whether the version information of the current primitive is consistent with the version information of the primitive in the primitive information module of the new version of the remote server. If inconsistent, the primitive can be updated.

The primitive interface description refers to description information composed based on primitive interface information. For example, different primitives have different interface compositions and have different primitive interface descriptions.

The primitive resource location refers to location information of a primitive resource. For example, a primitive resource can be found according to the location information of a primitive on a network.

The primitive extension module is a primitive collection which includes all the primitives. In which, the primitive includes primitive MP3 resources, primitive picture resources, primitive XML resources, and the like.

The local storage space refers to a storage space in a storage device built-in or connected to a terminal device currently executing a visual programming program.

In a specific application, step S101 may be implemented through an on demand loading management module. The on demand loading management module is a module based on Blockly technology. The on demand loading management module searches for the demanded primitive through the primitive information description of the primitive information module, and loads and stores the corresponding primitive resource on demand. In which, the on demand loading technology refers to the delay loading, that is, an object is loaded only while the object is to be used. Blockly technology refers to a graphical programming language named Google Blockly which is executed on a web page, in which each graphic object is a code block, so that a user can develop application programs by dragging jigsaw puzzles without any coding.

In one embodiment, before step S101, the method includes:

detecting a current network status; and

detecting whether the remote server includes the primitive information module of the new version, if the current network status is a network connected status.

In a specific application, detecting the current network status refers to detecting whether the current terminal is connected to the Internet or not. If connected to the Internet, it is in the network connected status; otherwise, it is in a network disconnected status.

S102: initializing a visual programming main interface.

In a specific application, the visual programming main interface allows a user to intuitively operate the main interface according to actual needs. For example, the user can operate demanded objects by dragging, sliding, etc., according to actual needs.

In one embodiment, step S102 specifically includes: constructing the visual programming main interface basing on the primitive category tree description in the primitive information module of the new version.

In a specific application, step S102 may be implemented through a kernel function module, where the kernel function module is a kernel module based on Blockly technology, and the kernel function module includes interface event reception, interface primitive parsing, primitive code generation and execution, and the like.

S103: obtaining a dummy primitive object selected by a user in the visual programming main interface.

In a specific application, the dummy primitive object specifically refers to a dummy object loaded with primitive information pointing to a real primitive object, where the real primitive object can be found by using the primitive information. The dummy object is a primitive public abstract class, which includes basic operation interfaces of primitives, for example, the event response interface, the primitive creation interface, the primitive release interface, the primitive callback function interface, the primitive display interface, and the like. In which, the abstract class refers to a class which does not include enough information to describe a specific object. A class is a user-defined type, also known as a class type. Each class includes data descriptions and a set of functions for manipulating data or delivering messages. An interface (software interface) refers to a reference type which is for defining an agreement. Other types implement interfaces to ensure that they support some operations. The interface specifies the members which must be provided by the class or other interfaces which implement it. Like the class, the interface may include methods, properties, indexers, and events as members.

In a specific application, the primitive information is from the primitive information module. The primitive information includes information such as the primitive classification, the primitive interface description, the primitive resource location, and may further include other primitive information descriptions.

In a specific application, step S103 may be implemented through the kernel function module.

S104: searching for the real primitive object corresponding to the dummy primitive object basing on primitive information of the dummy primitive object

In a specific application, step S104 may be implemented through the on demand loading management module.

S105: instantiating the real primitive object, and replacing the dummy primitive object with the real primitive object

In one embodiment, after step S105, the method includes:

releasing the dummy primitive object.

In a specific application, the resource utilization of the local storage space may be increased by releasing the dummy primitive object so as to improve the response speed and make the operation smoother.

In a specific application, step S105 may be implemented through the kernel function module.

In a specific application, through designing a visualization programming system in a modular manner according to its functions, in the network connected status, when the remote server is detected as including the primitive information module of the new version, only the primitive expansion module and the primitive information module have to be downloaded while there is unnecessary to download an update kernel function module and the on demand loading management module while performing upgrades, which reduces the download volume, shorten the download time, and is convenient for a user to perform the upgrade operation.

In one embodiment, the visual programming method may also be used in a terminal device which is capable of executing entertainment applications. By the above-mentioned method, the entertainment application resource deployed in the terminal device through the on demand loading technology is stored in the local storage space of the terminal device, which facilitates the offline execution of the executing entertainment applications so as to realize offline entertainment functions.

In this embodiment, through updating a primitive information module of a local storage space and initializing a visual programming main interface when a remote server is detected as including the primitive information module of a new version, obtaining a dummy primitive object selected by a user in the visual programming main interface, and then searching for a real primitive object corresponding to the dummy primitive object basing on primitive information of the dummy primitive object as well as instantiating the real primitive object and replacing the dummy primitive object with the real primitive object to update the primitive selected by the user, which can improve the online operation smoothness of the operation interface when Blockly technology is deployed on a mobile terminal platform, and reduce the download volume, so as to improve the download speed when the Blockly technology is deployed for the first time to realizes full localization or upgraded after full localization, hence the user experience is improved.

### Embodiment Two

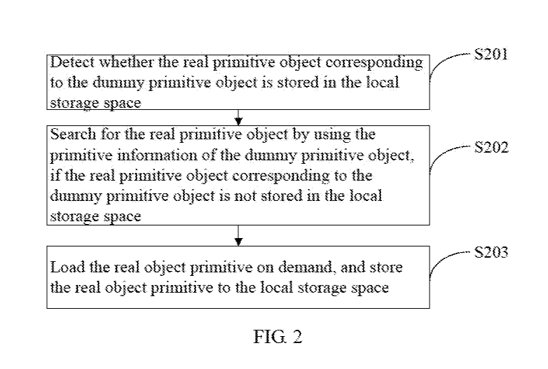

FIG. 2 is a flow chart of a visual programming method according to a second embodiment of the present disclosure. As shown in FIG. 2, step S104 in embodiment one includes the following steps.

S201: detecting whether the real primitive object corresponding to the dummy primitive object is stored in the local storage space.

S202: searching for the real primitive object by using the primitive information of the dummy primitive object, if the real primitive object corresponding to the dummy primitive object is not stored in the local storage space.

S203: loading the real object primitive on demand, and storing the real object primitive to the local storage space.

In a specific application, if the real primitive object corresponding to the dummy primitive object is not stored in the local storage space, primitive resource location information in the dummy primitive object is used to search for the real primitive object corresponding to the dummy primitive object, and the primitive resources of the real primitive object are downloaded through the on demand loading technology. The primitive resources of the real primitive objects include primitive resources such as primitive MP3 resources, primitive picture resources, primitive XML resources, and the like, and are stored to the local storage space to realize the localization of primitives.

In this embodiment, through detecting whether the real primitive object corresponding to the dummy primitive object is stored in the local storage space, searching for the real primitive object by using the primitive information of the dummy primitive object, if the real primitive object corresponding to the dummy primitive object is not stored in the local storage space, and then loading the real object primitive on demand and store the real object primitive to the local storage space, which updates the primitive which the user wants to updated and is not store in the local storage space, and the waiting time is reduced, the response speed and the user experience are improved.

### Embodiment Three

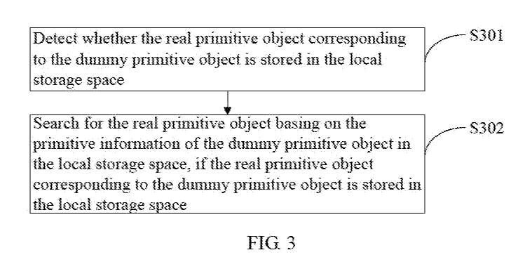

FIG. 3 is a flow chart of a visual programming method according to a third embodiment of the present disclosure. As shown in FIG. 3, step S104 in embodiment one further includes the following steps.

S301: detecting whether the real primitive object corresponding to the dummy primitive object is stored in the local storage space;

S302: searching for the real primitive object basing on the primitive information of the dummy primitive object in the local storage space, if the real primitive object corresponding to the dummy primitive object is stored in the local storage space.

In a specific application, if it is detected that the real primitive object corresponding to the dummy primitive object is stored in the local storage space, the real primitive object corresponding to the dummy primitive object is searched in the local storage space basing on the primitive information of the dummy primitive object, that is, the primitive classification, the primitive interface description, or the primitive resource location of the dummy primitive object.

In this embodiment, through detecting whether the real primitive object corresponding to the dummy primitive object is stored in the local storage space, and searching for the real primitive object basing on the primitive information of the dummy primitive object in the local storage space, if the real primitive object corresponding to the dummy primitive object is stored in the local storage space, which is based on the concise and accurate primitive information of the dummy primitive object, and can search out the real primitive object corresponding to the dummy primitive object quickly, and the response speed is improved.

It should be understood that, the number of each step in the above-mentioned embodiments does not mean the sequence of execution. Instead, the execution sequence of each process should be determined by its function and inherent logic, and should not constitute any limitation on the implementation process of the embodiments of the present disclosure.

### Embodiment Four

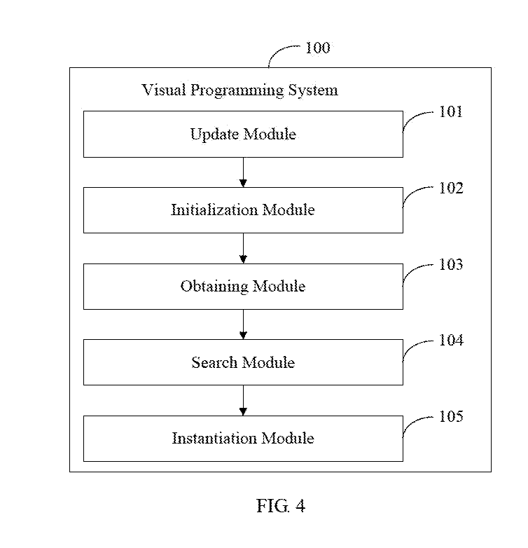

FIG. 4 is a schematic diagram of a visual programming system according to a fourth embodiment of the present disclosure. The system includes a processor and a memory storing instructions executable for the processor, where the instructions functions as an update module 101, an initialization module 102, an obtaining module 103, a search module 104, an instantiation module 105. As shown in FIG. 4, this embodiment provides a visual programming system 100 configured to perform the steps of the method in embodiment one.

The update module 101 is configured to update a primitive information module of a local storage space when a remote server is detected as including the primitive information module of a new version.

In a specific application, the update module 101 may be an on demand loading management module.

The initialization module 102 is configured to initialize a visual programming main interface

In a specific application, the initialization module 102 is specifically configured to:

construct the visual programming main interface basing on the primitive category tree description in the primitive information module of the new version.

In a specific application, the initialization module 102 may be a kernel function module.

The obtaining module 103 is configured to obtain a dummy primitive object selected by a user in the visual programming main interface

In a specific application, the obtaining module 103 may be a kernel functional module.

The search module 104 is configured to search for a real primitive object corresponding to the dummy primitive object basing on primitive information of the dummy primitive object.

In a specific application, the search module 104 may be an on demand loading management module.

The instantiation module 105 is configured to instantiate the real primitive object, and replacing the dummy primitive object with the real primitive object.

In a specific application, the instantiation module 105 may be a kernel function module.

In one embodiment, the visual programming system further includes:

a first detection module configured to detect a current network status; and

a second detection module configured to detect whether the remote server includes the primitive information module of the new version, if the current network status is a network connected status.

In one embodiment, the visual programming system further includes:

a release module configured to release the dummy primitive object.

In this embodiment, through updating a primitive information module of a local storage space and initializing a visual programming main interface when a remote server is detected as including the primitive information module of a new version, obtaining a dummy primitive object selected by a user in the visual programming main interface, and then searching for a real primitive object corresponding to the dummy primitive object basing on primitive information of the dummy primitive object as well as instantiating the real primitive object and replacing the dummy primitive object with the real primitive object to update the primitive selected by the user, which can improve the online operation smoothness of the operation interface when Blockly technology is deployed on a mobile terminal platform, and reduce the download volume, so as to improve the download speed when the Blockly technology is deployed for the first time to realizes fill localization or upgraded after full localization, hence the user experience is improved.

### Embodiment Five

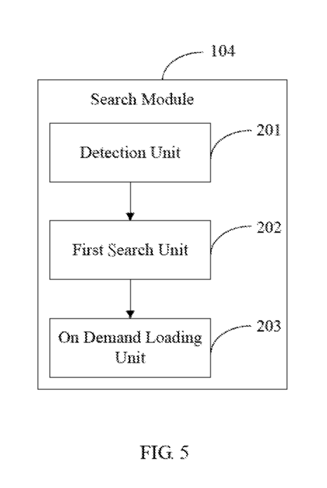

FIG. 5 is a schematic diagram of a visual programming system according to a fifth embodiment of the present disclosure. As shown in FIG. 5, the search module 104 in embodiment four includes:

a detection unit 201 configured to detect whether the real primitive object corresponding to the dummy primitive object is stored in the local storage space;

a first search unit 202 configured to search for the real primitive object by using the primitive information of the dummy primitive object, if the real primitive object corresponding to the dummy primitive object is not stored in the local storage space; and

an on demand loading unit 203 configured to load the real object primitive on demand, and store the real object primitive to the local storage space.

In this embodiment, through detecting whether the real primitive object corresponding to the dummy primitive object is stored in the local storage space, searching for the real primitive object by using the primitive information of the dummy primitive object, if the real primitive object corresponding to the dummy primitive object is not stored in the local storage space, and then loading the real object primitive on demand and store the real object primitive to the local storage space, which updates the primitive which the user wants to updated and is not store in the local storage space, and the waiting time is reduced, the response speed and the user experience are improved.

### Embodiment Six

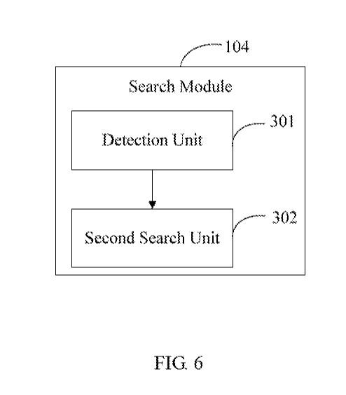

FIG. 6 is a schematic diagram of a visual programming system according to a sixth embodiment of the present disclosure. As shown in FIG. 6, the search module 104 in embodiment four further includes:

a detection unit 301 configured to detect whether the real primitive object corresponding to the dummy primitive object is stored in the local storage space; and

a second search unit 302 configured to search for the real primitive object basing on the primitive information of the dummy primitive object in the local storage space, if the real primitive object corresponding to the dummy primitive object is stored in the local storage space.

In this embodiment, through detecting whether the real primitive object corresponding to the dummy primitive object is stored in the local storage space, and searching for the real primitive object basing on the primitive information of the dummy primitive object in the local storage space, if the real primitive object corresponding to the dummy primitive object is stored in the local storage space, which is based on the concise and accurate primitive information of the dummy primitive object, and can search out the real primitive object corresponding to the dummy primitive object quickly, and the response speed is improved.

### Embodiment Seven

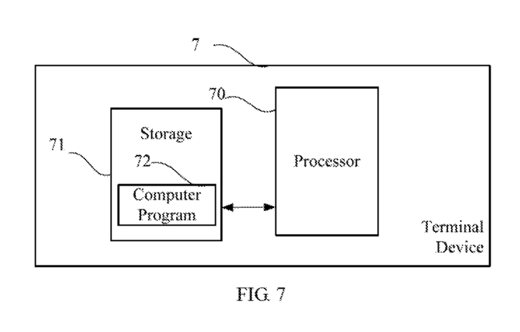

FIG. 7 is a schematic diagram of a terminal device according to a seventh embodiment of the present disclosure. As shown in FIG. 7, a terminal device 7 of this embodiment includes a processor 70, a storage 71, and a computer program 72 stored in the storage 71 and executable on the processor 70, for example, a visual programming program. When the processor 70 executes the computer program 72, the steps in the above-mentioned embodiments of the visual programming method are implemented, for example, steps S101-S105 shown in FIG. 1. Alternatively, when the processor 70 executes the computer program 72, the functions of each nodule/unit in the above-mentioned device/system embodiments, for example, the functions of the modules 101-105 shown in FIG. 4, are implemented.

Exemplarily, the computer program 72 may be divided into one or more modules/units, and the one or more modules/units are stored in the storage 71 and executed by the processor 70 to realize the present disclosure. The one or more modules/units may be a series of computer program instruction sections capable of performing a specific function, and the instruction sections are for describing the execution process of the computer program 72 in the terminal apparatus 7. For example, the computer program 72 may be divided into an update module, an initialization module, an obtaining module, a search module, and an instantiation module. Specific functions of each module are as follows:

the update module is configured to update a primitive information module of a local storage space when a remote server is detected as including the primitive information module of a new version;

the initialization module is configured to initialize a visual programming main interface;

the obtaining module is configured to obtain a dummy primitive object selected by a user in the visual programming main interface;

the search module is configured to search for a real primitive object corresponding to the dummy primitive object basing on primitive information of the dummy primitive object; and

the instantiation module is configured to instantiate the real primitive object, and replacing the dummy primitive object with the real primitive object.

The terminal device 7 may be a computing device such as a cell phone, a desktop computer, a notebook computer, a tablet computer, and a cloud server. The terminal device may include, but is not limited to, a processor 70 and a storage 71. It can be understood by those skilled in the art that FIG. 7 is merely an example of the terminal device 7 and does not constitute a limitation on the terminal device 7, and may include more or fewer components than those shown in the figure, or a combination of some components or different components. For example, the terminal device may further include an input/output device, a network access device, a bus, and the like.

The processor 70 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 71 may be an internal storage unit of the terminal device 7, for example, a hard disk or a memory of the terminal device 7. The storage 71 may also be an external storage device of the terminal device 7, for example, a plug-in hard disk, a smart media card (SMC), a secure digital (SD) card, flash card, and the like, which is equipped on terminal device 7. Furthermore, the storage 71 may further include both an internal storage unit and an external storage device, of the terminal device 7. The storage 71 is configured to store the computer program and other programs and data required by the terminal device 7. The storage 71 may also be used to temporarily store data that has been or will be output.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present application. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus/system/terminal device and method may be implemented in other manners. For example, the above-mentioned apparatus/system/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

1. A computer-implemented visual programming method, comprising executing on a processor steps of:
updating a primitive information module of a local storage space when a remote server is detected as including the primitive information module of a new version;
initializing a visual programming main interface;
obtaining a dummy primitive object selected by a user in the visual programming main interface;
searching for a real primitive object corresponding to the dummy primitive object basing on primitive information of the dummy primitive object; and
instantiating the real primitive object, and replacing the dummy primitive object with the real primitive object.

2. The method of claim 1, wherein the step of initializing the visual programming main interface comprises:
constructing the visual programming main interface basing on the primitive category tree description in the primitive information module of the new version.

3. The method of claim 1, wherein the step of searching for the real primitive object corresponding to the dummy primitive object basing on the primitive information of the dummy primitive object comprises:
detecting whether the real primitive object corresponding to the dummy primitive object is stored in the local storage space;
searching for the real primitive object by using the primitive information of the dummy primitive object, if the real primitive object corresponding to the dummy primitive object is not stored in the local storage space; and
loading the real object primitive on demand, and storing the real object primitive to the local storage space.

4. The method of claim 1, wherein the step of searching for the real primitive object corresponding to the dummy primitive object basing on the primitive information of the dummy primitive object comprises:
detecting whether the real primitive object corresponding to the dummy primitive object is stored in the local storage space; and
searching for the real primitive object basing on the primitive information of the dummy primitive object in the local storage space, if the real primitive object corresponding to the dummy primitive object is stored in the local storage space.

5. The method of claim 1, wherein after the step of instantiating the real primitive object, and replacing the dummy primitive object with the real primitive object further comprises:
releasing the dummy primitive object.

6. The method of claim 1, wherein before the step of updating the primitive information module of the local storage space when the remote server is detected as including the primitive information module of the new version further comprises:
detecting a current network status; and
detecting whether the remote server includes the primitive information module of the new version, if the current network status is a network connected status.

7. A visual programming system, comprising a processor and a memory storing instructions executable for the processor, wherein the instructions functions as:
an update module configured to update a primitive information module of a local storage space when a remote server is detected as including the primitive information module of a new version;
an initialization module configured to initialize a visual programming main interface;
an obtaining module configured to obtain a dummy primitive object selected by a user in the visual programming main interface;
a search module configured to search for a real primitive object corresponding to the dummy primitive object basing on primitive information of the dummy primitive object; and
an instantiation module configured to instantiate the real primitive object, and replacing the dummy primitive object with the real primitive object.

8. The system of claim 7, wherein the initialization module is configured to construct the visual programming main interface basing on the primitive category tree description in the primitive information module of the new version.

9. The system of claim 7, wherein the search module comprises:
a detection unit configured to detect whether the real primitive object corresponding to the dummy primitive object is stored in the local storage space;
a first search unit configured to search for the real primitive object by using the primitive information of the dummy primitive object, if the real primitive object corresponding to the dummy primitive object is not stored in the local storage space; and
an on demand loading unit configured to load the real object primitive on demand, and store the real object primitive to the local storage space.

10. The system of claim 7, wherein the search module comprises:
a detection unit configured to detect whether the real primitive object corresponding to the dummy primitive object is stored in the local storage space; and
a second search unit configured to search for the real primitive object basing on the primitive information of the dummy primitive object in the local storage space, if the real primitive object corresponding to the dummy primitive object is stored in the local storage space.

11. The system of claim 7, wherein the instructions further functions as:
a release module configured to release the dummy primitive object.

12. The system of claim 7, wherein the instructions further functions as:
a first detection module configured to detect a current network status; and
a second detection module configured to detect whether the remote server includes the primitive information module of the new version, if the current network status is a network connected status.

13. A terminal device for visual programming, comprising:
one or more processors;
a memory; and
one or more programs, wherein the one or more programs are stored in the memory and configured to be executed by the one or more processors, the one or more programs comprises:
instructions for updating a primitive information module of a local storage space when a remote server is detected as including the primitive information module of a new version;
instructions for initializing a visual programming main interface;
instructions for obtaining a dummy primitive object selected by a user in the visual programming main interface;
instructions for searching for a real primitive object corresponding to the dummy primitive object basing on primitive information of the dummy primitive object; and
instructions for instantiating the real primitive object, and replacing the dummy primitive object with the real primitive object.

14. The terminal device of claim 13, wherein the instructions for initializing the visual programming main interface comprises:
instructions for constructing the visual programming main interface basing on the primitive category tree description in the primitive information module of the new version.

15. The terminal device of claim 13, wherein the instructions for searching for the real primitive object corresponding to the dummy primitive object basing on the primitive information of the dummy primitive object comprises:
instructions for detecting whether the real primitive object corresponding to the dummy primitive object is stored in the local storage space;
instructions for searching for the real primitive object by using the primitive information of the dummy primitive object, if the real primitive object corresponding to the dummy primitive object is not stored in the local storage space; and
instructions for loading the real object primitive on demand, and storing the real object primitive to the local storage space.

16. The terminal device of claim 13, wherein the instructions for searching for the real primitive object corresponding to the dummy primitive object basing on the primitive information of the dummy primitive object comprises:
instructions for detecting whether the real primitive object corresponding to the dummy primitive object is stored in the local storage space; and
instructions for searching for the real primitive object basing on the primitive information of the dummy primitive object in the local storage space, if the real primitive object corresponding to the dummy primitive object is stored in the local storage space.

17. The terminal device of claim 13, wherein the one or more programs further comprises:
instructions for releasing the dummy primitive object.

18. The terminal device of claim 13, wherein the one or more programs further comprises:
instructions for detecting a current network status; and
instructions for detecting whether the remote server includes the primitive information module of the new version, if the current network status is a network connected status.

19. The method of claim 1, wherein the dummy primitive object is a primitive public abstract class comprising basic operation interfaces of primitives.

20. The system of claim 7, wherein the dummy primitive object is a primitive public abstract class comprising basic operation interfaces of primitives.
